(19) United States
(12) Patent Application Publication
(10) Pub. No.: US 2005/0095057 A1
(43) Pub. Date: May 5, 2005

(54) Notebook with pencil storage cutout

(76) Inventor: Kate O'Hara, Bexley, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/702,222

(22) Filed: Nov. 5, 2003

(51) Int. Cl. B42F 3/06

(52) U.S. Cl. 402/57

(57) ABSTRACT

A notebook including a plurality of sheets of paper bound together. Each paper of the plurality of sheets having a generally elongate opening located therein, each opening being aligned with an opening of any adjacent sheets of paper and being sized and shaped to receive a writing instrument therethrough. The notebook further includes a cover coupled to the plurality of sheets of paper, the cover being movable to a closed position wherein the cover is generally parallel to and faces a top sheet of the plurality of sheets of paper. The cover has at least one of a thickness or stiffness that is greater than each sheet of the plurality of sheets of paper. The notebook further includes a retaining mechanism to retain the cover in the closed position.

The present invention is directed to a notebook, and more particularly, to a notebook with a cutout formed at least partially through the thickness of the notebook for receiving a writing instrument therein.

### BACKGROUND

Notebooks are typically used by students, professionals, and other users as a device for providing paper, storage space, as well as a support surface when writing notes. A writing instrument is thus often required so that a user can write on the papers stored in the notebook. Accordingly, there is a need for a notebook having a location for storing a writing instrument.

### SUMMARY

In one embodiment, the invention is a notebook having a plurality of sheets wherein each of the sheets has a cutout formed therein such that when the sheets are arranged in a stack, and the cutouts define a cavity in which a writing instrument may be stored.

In particular, in one embodiment, the invention is a notebook including a plurality of sheets of paper bound together. Each paper of the plurality of sheets having a generally elongate opening located therein, each opening being aligned with an opening of any adjacent sheets of paper and being sized and shaped to receive a writing instrument therethrough. The notebook further includes a cover coupled to the plurality of sheets of paper, the cover being movable to a closed position wherein the cover is generally parallel to and faces a top sheet of the plurality of sheets of paper. The cover has at least one of a thickness or stiffness that is greater than each sheet of the plurality of sheets of paper. The notebook further includes a retaining mechanism to retain the cover in the closed position. Other objects and advantages of the present invention will be apparent from the following description and the accompanying drawings.

### BRIEF DESCRIPTION OF THE DRAWINGS

FIG. 1 is a front perspective view of one embodiment of the notebook of the present invention, shown in its open position;

FIG. 2 is a front perspective view of the notebook of FIG. 1 with a writing instrument located therein;

FIG. 3 is a front perspective view of the notebook of FIG. 1, shown in its closed position;

FIG. 4 is a side cross section of the notebook of FIG. 2; and

FIG. 5 is a top view of the cavity of the notebook of FIG. 1, illustrating various dimensions.

### DETAILED DESCRIPTION

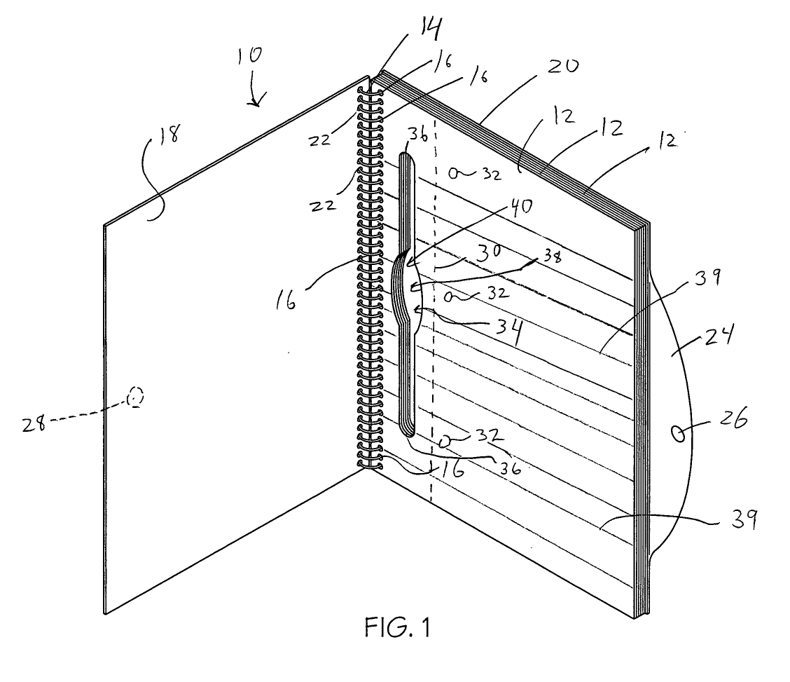

As shown in FIG. 1, in one embodiment the invention is a notebook, generally designated 10, which includes a plurality of paper sheets 12 bound by a binding mechanism 14. Each of the sheets 12 may include a set of lines 39 located thereon to guide the writing of a user. However, the paper 12 may not include lines or may include various other arrangements of lines, such as grids, patterns, etc. The bound papers 12 may also be made of wide variety of materials, and have a variety of colors, textures, etc.

In the illustrated embodiment, the binding mechanism 14 is a spiral binding mechanism. Thus, each of the papers 12 may include a plurality of small binding holes 16 located at or adjacent to their inner edges to accept a turn of the coil 16 therethrough. However, the binding mechanism 14 may include any of a wide variety of well-known binding means or mechanisms, including coil binding mechanisms, adhesives, spines, prongs, clips, tabs and the like.

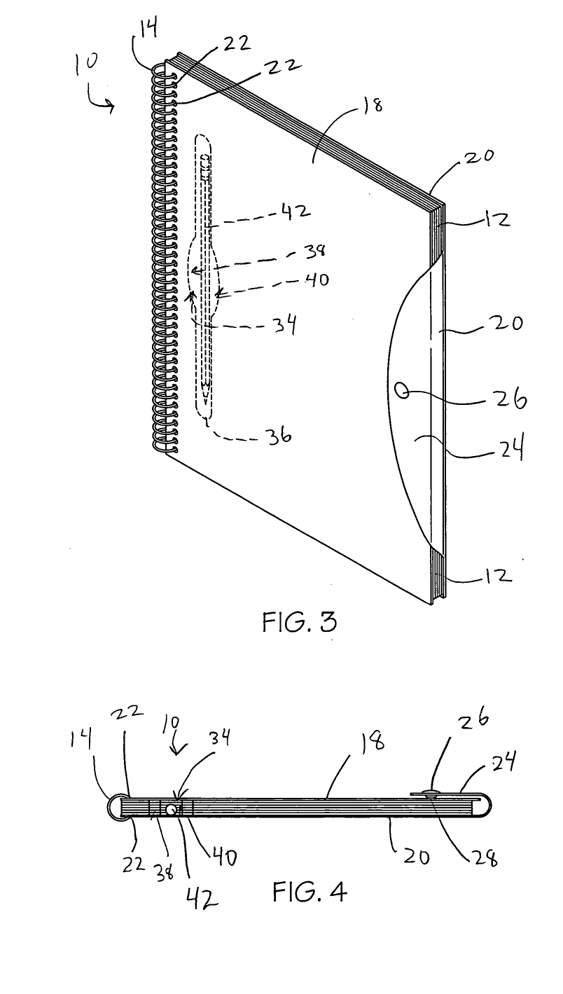

The notebook 10 may include front 18 and rear 20 covers located on either side of the papers 12, such that, when the binder 10 is in its closed position (as shown in FIGS. 3 and 4), the papers 12 may be generally parallel to and located between the front 18 and rear 20 covers. Each of the front 18 and rear 20 covers, as well as the papers 12, may be made of generally flat, rectangular material. Furthermore, the front 18 and rear 20 covers may be made of material that is thicker and/or stiffer than the papers 12 to provide structural stiffness to the notebook 10, as well as to provide a support surface when the user writes on the notebook 10 (i.e., when the notebook 10 is supported on the lap of the user). When a spiral 14 or similar binding mechanism is used, each of the covers 18, 20 may have a binding hole 22 located at or adjacent to its inner edge.

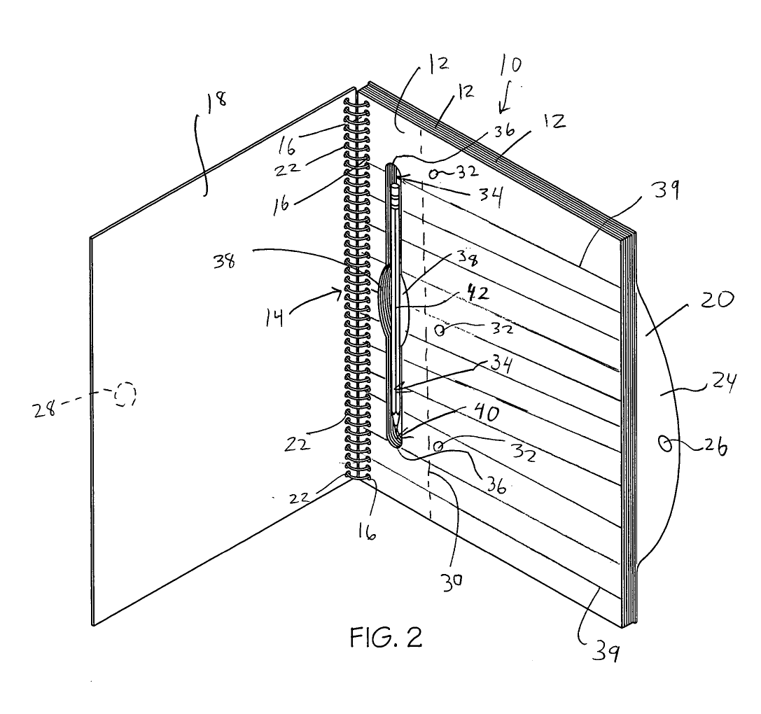

The rear (or supplemental) cover 20 may be directly releasably attachable to the front cover 18. For example, in the illustrated embodiment, the rear cover 20 includes a flap 24 located at its central portion and extending outwardly beyond the pages 12, with the flap 24 including a female snap component 26. The front cover 18 includes a corresponding male snap component 28 located at its outer edge and on the front surface thereof. FIGS. 1 and 2 illustrate the notebook 10 in its open position wherein the front cover 18 generally does not face the rear cover 20, and/or is not generally parallel to the rear cover 20 and/or stack of papers 12. Thus, when the notebook 10 is moved to its closed position (FIG. 3) such that the front 18 and rear 20 covers are generally parallel and facing each other with the plurality of papers 12 located therebetween, the flap 24 may be folded about the ends of the papers 12 and the outer edge of top cover 18 such that the female snap component 26 securely fits over the male snap component 28. In this manner, when the covers 18, 20 are coupled together, the notebook 10 and covers 18, 20 may be retained in the closed position.

Of course, a wide variety of attachment mechanisms, besides the male/female snap components 26, 28 disclosed in the drawings, may be used without departing from the scope of the invention. For example, hook-and-loop (i.e., VELCRO®) attachment systems, interengaging geometries, clasps, clips, magnets, ties, cords, etc. may be used to releasably couple the front 18 and rear 20 covers together.

Each paper 12 may include a tear guideline, such as a perforation line 30 (FIG. 1), extending generally along the longitudinal direction of each paper 12 and adjacent to the binding mechanism 14. In this manner, each paper 12 may be able to be torn along its perforation line 30 to remove the paper 12 from the binding mechanism 14 and from body of the notebook 10 for separate use. Furthermore, each paper 12 may include a set of holes 32 (i.e., three spaced holes for use in a three-ring binder) located adjacent to an inner edge of the paper 12 so that a separated paper 12, or the notebook 10 as a whole, may be stored in a three-ring binder or other appropriate external binding mechanism.

As shown in FIG. 1, each of the sheets of paper 12 may include a cutout 34 formed therein. In the illustrated embodiment, each cutout 34 is generally rectangular or longitudinal in shape, and has rounded tips or ends 36. Each cutout 34 may also include a central area of widening 38 or “bulge” that extends at least partially in a direction generally perpendicular to the length or central axis of each cutout 34. Each of the cutouts 34 may be aligned such that when the papers 12 are stacked by the binding mechanism 14, the cutouts 34 may form a cavity 40.

As shown in FIG. 2, the cavity 40 may be shaped to receive a writing instrument 42, such as a pen, pencil, marker or the like therein. Thus, the elongate shape of the cavity may be formed to closely receive a writing instrument 42 therein. In one embodiment, the cavity 40 may be at least six inches long, although the cavity 40 can be longer or shorter as desired. The cavity 40 may be generally elongate and thus have a length-to-width ratio of at least about 6:1, or about 12:1, although this ratio can be adjusted as desired. The central area of widening 38 of the cavity 40 provides space on either side of a writing instrument received therein so that a user can reach into the area of widening 38 to grasp a writing instrument 42 stored in the cavity 40 with, for example, the user's thumb and forefinger.

Because the front 18 and rear 20 covers are releasably attachable, as noted above, the notebook 10 can be maintained in its closed position. When the notebook 10 is maintained in its closed position, as shown in FIGS. 3 and 4, the front cover 18 may be securely held in place against the top sheet of the stack of papers 12, and the rear cover 20 may be held in place against the bottom sheet of the stack of papers 12. Thus, the front 18 and rear 20 covers provide top and bottom “walls” to the cavity 40 such that when the notebook 10 is in its closed position, a writing instrument 42 is securely trapped inside the cavity 40.

Thus, each of the front 18 and rear 20 covers may lack a cutout or lack a cutout that is aligned with the cavity 40. In other words, although the front 18 and rear 20 covers may include openings or cutouts, and may even have openings or that are located above the cavity 40, such openings should not be sized and aligned with the cutouts 34 of the paper 12 such that a writing instrument 42 stored in the cavity 40 can pass through either of the covers 18, 20, while the writing instrument (i.e., its central axis) remains generally parallel to the cover. Thus, in one embodiment, each cover 18, 20 may lack any openings of equal or greater size (i.e., in one case, a surface area) than the cutouts 34 of each sheet of paper 12. At least one or each of the covers 18, 20, may cover at least about 80%, or about 50%, or about 25% or more or less of the cavity 40.

Thus, the cavity 40 may be sized to receive a writing instrument having a length between about 4 and 7 inches and having a width between about 1/8 inch and about 1 inch. One or each of the covers 18, 20 may lack any openings that would allow such a writing instrument to pass therethrough when such a writing instrument remains generally parallel to the covers 18, 20 (i.e., as shown in FIGS. 2-4).

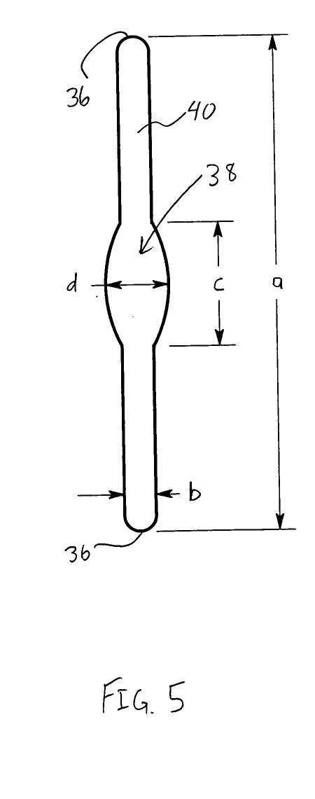

FIG. 5 illustrates various dimensions for the cavity 40. However, it should be understood that the dimension included herein are merely illustrative of one embodiment, and the invention is not limited to the specific dimension. The cavity 40 may have a height or length a of between about 6 inches to about 10 inches (about 8 inches in one embodiment) and a width b of between about 0.25 inches to about 1 inch (about 0.50 inches in one embodiment). The area of widening 38 may have a height or length c of between about 1 inch and 3 inches (about 2 inches in one embodiment), and a maximum width d of between about 1 inch and about 3 inches (about 1 inch in one embodiment).

Having described the invention in detail and by reference to the preferred embodiments, it will be apparent that modifications and variations thereof are possible without departing from the scope of the invention.

1. A notebook comprising:
a plurality of sheets of paper bound together, each paper of said plurality of sheets having a generally elongate opening located therein, each opening being aligned with an opening of any adjacent sheets of paper and being sized and shaped to receive a writing instrument therethrough;
a cover coupled to said plurality of sheets of paper, said cover being movable to a closed position wherein said cover is generally parallel to and faces a top sheet of said plurality of sheets of paper, said cover having at least one of a thickness or stiffness that is greater than each sheet of said plurality of sheets of paper; and
a retaining mechanism to retain said cover in said closed position.

2. The notebook of claim 1 wherein said cover lacks any opening that is of the same size and shape of said opening of said sheets of paper that is aligned with said opening of each sheet of paper.

3. The notebook of claim 1 wherein each of said plurality of sheets of paper and said cover are generally aligned.

4. The notebook of claim 1 wherein each of said plurality of sheets of paper includes a plurality of lines printed thereon.

5. The notebook of claim 1 further including a binding mechanism binding said sheets of paper and said cover together.

6. The notebook of claim 5 wherein said binding mechanism is a spiral binder.

7. The notebook of claim 5 wherein said generally elongate openings are located generally adjacent to said binding mechanism.

8. The notebook of claim 1 wherein said cover is pivotally bound to said plurality of sheets of paper such that said cover is movable to an open position in which the cover is generally not parallel with said plurality of sheets of paper.

9. The notebook of claim 1 wherein said cover lacks any openings of equal or greater size than said generally elongate openings of said plurality of sheets of paper.

10. The notebook of claim 1 wherein each of said sheets and said cover include a plurality of binding holes located adjacent to an inner edge thereof.

11. The notebook of claim 1 wherein said notebook further includes a supplemental cover pivotally coupled to said plurality of sheets of paper, wherein said retaining mechanism includes a flap coupled to said supplemental cover which can be removably coupled to said cover to retain said cover in said closed position.

12. The notebook of claim 11 wherein said one of said cover or said supplemental cover includes a male snap portion and the other ones of said cover or said supplemental cover includes a female snap portion, wherein said male snap portion and said female snap portion can cooperate to maintain said cover in said closed position.

13. The notebook of claim 1 wherein each opening includes an enlarged portion.

14. The notebook of claim 13 wherein said enlarged portion is generally centrally located along a length of each opening.

15. The notebook of claim 13 wherein said enlarged portion extends at least partially in a direction generally perpendicular to a length of each opening.

16. The notebook of claim 1 wherein each opening is at least about six inches in length.

17. The notebook of claim 1 wherein each opening includes a length-to-width ratio of at least about 6:1.

18. The notebook of claim 1 further including a writing instrument located in said generally elongate openings.

19. The notebook of claim 1 wherein each sheet includes a tear guide line extending generally parallel to an edge of each paper such that each sheet can be torn along its associated tear guideline and removed from said notebook.

20. The notebook of claim 1 wherein said cover covers at least about 50% of said openings of said sheets of paper.

21. The notebook of claim 1 wherein said cover is configured to retain a writing instrument located in said openings when a writing instruments is located in said openings and said cover is retained in said closed position by said retaining mechanism.

22. The notebook of claim 1 wherein said cover is configured to retain a writing instrument located in said openings when a writing instruments having a length of at least about 6 inches is located in said openings and said cover is retained in said closed position by said retaining mechanism.

23. The notebook of claim 1 wherein each opening is sized to receive a writing instrument having a length of between about 4 inches and about 7 inches, and having a width of between about 1/8 inch and about 1 inch, and wherein said cover lacks any opening that would allow such a writing instrument to pass therethrough while said writing instrument remains generally parallel to said cover.

24. A notebook comprising:
a plurality of sheets of paper bound together, each paper of said plurality of sheets having a generally elongate opening located therein, each opening being aligned with an opening of any adjacent sheets of paper and being sized and shaped to receive a writing instrument therethrough;
a cover coupled to said plurality of sheets of paper, said cover being movable to a closed position wherein said cover is generally parallel and faces a top sheet of said plurality of sheets of paper, said cover lacking any opening that would allow a writing instrument to pass therethrough while said writing instrument remains generally parallel to said cover; and
a retaining mechanism to retain said cover in said closed position.

25. A notebook comprising:
a plurality of sheets of paper bound together, each paper of said plurality of sheets having a generally elongate opening located therein, each opening being aligned with an opening of any adjacent sheets of paper and being sized and shaped to receive a writing instrument therethrough;
a cover coupled to said plurality of sheets of paper, said cover being movable to a closed position wherein said cover is generally parallel to and faces a top sheet of said plurality of sheets of paper, wherein said cover lacks any opening that is of the same size and shape of said opening of said sheets of paper that is aligned with said opening of each sheet of paper; and
a retaining mechanism to retain said cover in said closed position.

26. A notebook comprising:
a plurality of sheets of paper bound together, each paper of said plurality of sheets having a generally elongate opening located therein, each opening being aligned with an opening of any adjacent sheets of paper and being sized and shaped to receive a writing instrument therethrough;
a front cover coupled to said plurality of sheets of paper, said front cover having at least one of a thickness or stiffness that is greater than each sheet of said plurality of sheets of paper; and
a rear cover coupled to said plurality of sheets of paper, said rear cover having at least one of a thickness or stiffness that is greater than each sheet of said plurality of sheets of paper, said notebook being movable to a closed position wherein said front cover and said rear cover are generally parallel and said plurality of sheets of paper are located between said front and rear cover, and wherein said front and rear covers are releasably attachable together to retain said notebook in said closed position.
